(19) United States
(12) Patent Application Publication
(10) Pub. No.: US 2023/0421258 A1
(43) Pub. Date: Dec. 28, 2023

(54) CAPTURING SIGNALS IN FREE SPACE OPTICAL COMMUNICATIONS

(71) Applicant: 8 Rivers Capital, LLC, Durham, NC (US)

(72) Inventor: Alok Grover, Durham, NC (US)

(21) Appl. No.: 18/037,492

(22) PCT Filed: Nov. 30, 2021
(86) PCT No.: PCT/US2021/061217

§ 371 Date: May 17, 2023

Related U.S. Application Data
(60) Provisional application No. 63/116,266, filed on Nov. 20, 2020.

(51) Int. Cl. H04B 10/112

(52) U.S. Cl. CPC H04B 10/1123

(57) ABSTRACT

An optical communication system is provided that includes a first node and a second node. Each node of the first node and the second node includes transmit optics, receive optics. Each node also includes an optical transceiver module configured to provide optical signals to the transmit optics over a first optical conduit, and receive optical signals from the receive optics over a second optical conduit that has a core diameter larger than the first optical conduit. The transmit optics of the first node is configured to transmit first optical signals in free space for receipt by the receive optics of the second node, and the transmit optics of the second node is configured to transmit the second optical signals in free space for receipt by the receive optics of the first node.

### TECHNOLOGICAL FIELD

The present disclosure relates generally to optical communication and, in particular, to capturing signals in a free space optical communication system, enabling improved signal transmission over free space between points which would otherwise require a physical connection such as wires or fiber optics.

### BACKGROUND

Many free space optical (FSO) communication systems have been developed in the past using some combination of including but not limited to optical assemblies, fiber, amplifiers, and detectors. Some detectors operate at wavelengths where higher transmitter powers (typically, but not limited to, 0.1-1000 watts) can be cost effectively generated using an optical amplifier. An optical amplifier enables a high frequency signal modulated at low power to be amplified to higher power levels without requiring electrical modulation at the higher power levels, which is problematic at higher frequencies.

The most common optical amplifiers are Erbium Doped Fiber Amplifiers (EDFA's) at around 1550 nm, but high-power amplifiers are also available at other wavelengths, including but not limited to optical amplifiers at 1000-1600 nm, and silicon optical amplifiers, Raman amplifiers, and other types, at UV, visible, and infrared wavelengths. Many of these amplifiers have not been extensively developed commercially due to the lack of a market for them because the telecommunications windows for fiber optics are only present in certain bands, such as 1500 nm, 1300 nm, and other restricted pass bands where fiber losses are low.

In general, a free space optics system includes a transmitter transmitting an optical signal and a receiver on the other end to receive the signal. The mechanism used to receive light usually includes an optical lens that focuses light on to a detector which converts the optical signal into an electrical signal. In some cases, an optical fiber is used to couple light from the optical lens to the detector. These systems usually employ longer wavelengths such as 1490-1625 nm owing to low attenuation, eye safety, and amplifiability by means of an optical amplifier.

The two most widely used optical fibers used in the industry are single-mode (SM) fiber and multimode (MM) fiber. SM fibers have much smaller core diameters than MM fibers. A SM fiber has a core diameter of about 9 microns with a numerical aperture (NA) typically around 0.1. A multimode fiber has a core diameter of about 50/62.5 microns with NA typically around 0.3. SM fiber is designed to propagate only a single mode from a light source. MM fiber allows higher order modes to propagate from a light source. MM fiber is typically used when beam shape and quality is not a desirable factor. MM fiber is used to deliver as much light down the fiber as possible. MM fibers in turn have large NAs while SM mode fibers have smaller NAs. A MM fiber suffers from higher dispersion, and attenuation losses leading to degradation of signal quality with distance when compared to SM fiber.

### BRIEF SUMMARY

Example implementations of the present disclosure are directed to optical communication and, in particular, to capturing signals in a FSO communication system, enabling improved signal transmission over free space between points which would otherwise require a physical connection such as wires or fiber optics. Example implementations are directed to free space communications where the wavelength pass bands of fiber optics are not a limitation. FSO communications thus have great advantages in both wavelength flexibility and in the elimination of the need for a physical wire or fiber connection. In addition, a physical wire or fiber can only connect two points together, making a point to point connection. Free space optics can achieve many point to one point, one point to many point, and many point to many point connections.

The detectors designed for 1550 nm wavelength present in a transceiver module are designed to accept signals via a SM fiber. Given the random distribution of the light information in the fiber, the information is not uniformly spread in the fiber creating a speckle pattern. For this reason, all the spectral modes in the multimode fiber are not necessarily coupled into the smaller core SM fiber driven components inducing likely spectral information losses. Because this speckle pattern results from the interference of the propagation modes in the fibers, it makes it tremendously sensitive to environmental variations such as temperature, vibration, etc. For this reason, the speckle pattern is extremely unstable thus making transmitted signal in the SM fiber driven components unstable.

Example implementations of the present disclosure are premised on the revelation that MM fiber can actually be used with single mode driven components provided the optical power requirement of the receiver is taken into account. If the power is too high, it will most likely damage or render the detector useless. Therefore, different methods such as attenuators, optical fiber length, optical assembly, spot size modification, etc. can be employed to ensure the power received is in accordance with the receiver's sensitivity used. If the power is too low such as in case of long range FSO links or optical losses, one might want to increase the power at the receiver by means of an optical amplifier.

Example implementations use a working combination of fiber core diameter and NA, along with transceivers for electrical-to-optical (EO) and optical-to-electrical (OE) conversions. As used herein, a large fiber is an optical fiber with a diameter and/or NA greater than the current standard SM fiber having a core diameter of about 9 microns, and NA of about 0.1. In some examples, the large fiber can have a diameter less than 15 microns. In another example the large fiber can have a diameter between 15-35 micron. Yet in another example the diameter can be between 35-100 micron. While in some examples the diameter can be larger than 100-1000 micron. The NA for the fibers can be in the range of 0.1-0.3, 0.3-0.5, 0.5-0.6 or greater than 0.6. A large fiber can be a multimode fiber, mode conditioning fiber, light guide, light pipe, infrared (IR) light tubes/pipes, light tubes as an optical conduit to put light on to the detector, and the like or a mechanism/structure to capture signal from large aperture to small aperture or vice versa. Some examples may include optical amplifiers such as erbium doped fiber amplifiers (EDFA) after the transmit portion of a transceiver and/or before the receive portion of a second transceiver. Some examples may use a pointing and tracking mechanism to align a transceiver assembly with a second transceiver assembly on the other end of a free space link.

Some example implementations use a large fiber to couple light into a receiver, such as between an optical assembly and the receiver. Optical signal collection in an optical communication system according to example implementations offers a number of benefits:
1. A large fiber having large diameter with high NA may offer more collection area to collect signal, where in the collection area is the cross-section area of the fiber;
2. Coupling the signal to a second receiver with a large fiber may offer more available signal power, thus making it possible to increase the range of the link;
3. When compared to using a small fiber, a large fiber system may collect signals more efficiently and thereby eliminate a need for an optical amplifier;
4. A large fiber system may also make it easier to maintain beam alignment and thereby eliminate the need for an expensive pointing and tracking alignment system; and
5. A large collection area may compensate for the sway of a building or other support due to thermal expansion or wind from causing a communication link to go down.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates an optical communication system, according to some example implementations of the present disclosure;

FIGS. 2 and 3 illustrate portions of an optical communication system, according to other example implementations;

FIG. 4 illustrates an example without optical fiber, according to some example implementations; and

FIG. 5 illustrates an example with active pointing and/or tracking, according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

Example implementations of the present disclosure propose different techniques including collection of one or more signals via an optical fiber having a working combination of core diameter and NA. The optical fiber is larger in cross-section area and/or numerical aperture (NA) when compared to SM fiber. The collection of signals via a large fiber in a single mode system forms the basis of at least some example implementations of the present disclosure. Some example implementations connect an optical assembly to a detector using a large fiber that provides a large signal collection area compared to a small fiber, and thereby increases the amount of light that can be transmitted to the detector.

A system according to some example implementations uses a transmit beam with a beam diameter that is adjusted for eye safety. The distance at which the system becomes eye safe may be majorly a function of launch power, divergence/convergence angle, optical assembly, and the distance from the unit. The system may have a beam diameter of at least 1 mm to a diameter that makes the system eye safe at the launch power of the system. The divergence angle can be less than 1 degree, between 1 and 5 degrees, 5 and 20 degrees, 20 and 60 degrees, 60 and 120 degrees, 120 and 180 degrees, or 180 and 360 degrees. The convergence angle can be adjusted to make a link operable. The other variables as stated above can be adjusted independent of whether the system is eye safe or not. It must be noted that the variables can be adjusted where the system might not be eye safe. In various examples, the launch power may be in the range 1 mW to 500 mW. In other examples, the launch power may be in the range 500 mW to 5 W. And in yet other examples, the launch power may be in the range 1 mW to 1000 W.

The system may include electrical-to-optical (EO) and optical-to-electrical (OE) electronics and optics that are similar to what is used in other FSO links and in fiber optic links. Example implementations of the present disclosure leverage the low cost, low form factor, and high performance of fiber optic transceivers in the FSO communication links. Using fiber optic transceiver modules along with diverged or converged beam optics configurations, high bandwidth links may be built at much lower cost compared to custom EO and OE electronics and optics.

Table 1 below shows a sample link budget model for a FSO communication system according to some example implementations of the present disclosure. The system is configured to transmit an optical signal at 17 dBm, with a beam diameter of 7 mm and beam divergence half-angle of 0.140 mrad, over a distance of 100 m. The atmospheric attenuation is taken as 1 dBm per 100 m representative of thin fog condition with a visibility of 1-2 Km. The signal is received by an optical assembly with a lens having NA of 0.748 and acceptance angle of 48.42 degrees. A large fiber with NA of 0.275 and core diameter 0.0625 mm is used to couple the optical assembly and a detector in the transceiver module. The detector, designed to receive light from small fiber, is coupled using a large fiber resulting in an observed signal power loss of 65%.

TABLE 1
FSO Link Budget Model

| Transmitter | Launch Power, W | 0.050 | dBm | 17 |
|---|---|---|---|---|
| | Transmitter Loss | 0.50% | | |
| | Effective Launch Power, W | 0.0498 | | |
| | Beam Diameter, mm | 7 | m | 0.070 |
| | Beam Divergence Half-Angle, Degrees | 0.008 | mrad | 0.140 |
| Free Space | Range, m | 100 | | |
| | Atmospheric Losses, | 1 | W per | 0.001 |
| | dBm per 100 m | | 100 m | |
| | Power at Range, W | 0.050 | | 16.957 |
| | Spot Diameter at Range, m | 0.035 | | |
| | Power Density at Range, W/mm2 | 0.0000518 | dBm | −12.857 |
| Receiver | Receive Optics | | | |
| | Focal Length, mm | 12.7 | | |
| | Diameter, mm | 19 | | |
| | NA | 0.748 | | |
| | Acceptance Angle, Degrees | 48.42 | | |
| | Power at Receive Aperture, W | 0.0146866 | dBm | 11.669 |
| | Multimode Fiber | | | |
| | NA | 0.275 | | |
| | Core Size, mm | 0.0625 | micron | 62.5 |
| | Coupling Loss | 65% | | |
| | Optical Area from Detector Etendue | 0.005 | | |
| | Power at Detector, W | 4.02E−03 | dBm | 6.040 |

Tables 2 and 3 below show signal power received by the detector at a given launch power of 17 dBm using a 9-micron and 62.5-micron fiber core, respectively, for different NA values. As can be seen, more light is collected using a large fiber resulting in a greater range compared to a system using a small fiber. The collection area of a 62.5-micron fiber is 48 times larger than a 9-micron fiber. For a transmission range of 100 m, the power collected in a 62.5-micron, 0.275 NA fiber is about 19 times more than a 9-micron, 0.275 NA fiber; and the power collected is 148 times more than a standard 9-micron, −0.1 NA fiber. Further, the link with 62.5-micron fiber compared to a 9-micron fiber may have more range and a greater link margin. Example implementations of the present disclosure provide a large collection area for capturing light, which may eliminate the need for precise pointing of the laser. The system may also tolerate sway of the system or its support (e.g., building) approximately 10.5 mrad, which may eliminate the need for active tracking, or an expensive pointing and tracking system.

TABLE 2
9-Micron Fiber

| | | NA | | | | | | | | |
|---|---|---|---|---|---|---|---|---|---|---|
| | −6.791 | 0.05 | 0.1 | 0.2 | 0.3 | 0.4 | 0.5 | 0.75 | 0.9 | 0.95 |
| Range | 100 | −21.71 | −15.68 | −9.61 | −6.01 | −12.74 | −1.31 | 2.88 | 5.29 | 6.27 |
| | 200 | −26.93 | −20.89 | −14.83 | −11.23 | −17.96 | −6.53 | −2.34 | 0.07 | 1.05 |
| | 300 | −30.24 | −24.20 | −18.14 | −14.54 | −21.27 | −9.84 | −5.65 | −3.24 | −2.26 |
| | 400 | −32.69 | −26.65 | −20.59 | −16.99 | −23.72 | −12.29 | −8.10 | −5.69 | −4.71 |
| | 500 | −34.65 | −28.61 | −22.55 | −18.95 | −25.68 | −14.25 | −10.06 | −7.65 | −6.67 |
| | 750 | −38.35 | −32.32 | −26.26 | −22.66 | −29.39 | −17.96 | −13.77 | −11.35 | −10.38 |
| | 1,000 | −41.14 | −35.10 | −29.04 | −25.44 | −32.17 | −20.74 | −16.55 | −14.14 | −13.16 |
| | 1,500 | −45.39 | −39.36 | −33.30 | −29.70 | −36.42 | −25.00 | −20.81 | −18.39 | −17.41 |
| | 2,000 | −48.85 | −42.81 | −36.75 | −33.15 | −39.88 | −28.45 | −24.26 | −21.85 | −20.87 |

TABLE 3
62.5-Micron Fiber

| | | NA | | | | | | | | |
|---|---|---|---|---|---|---|---|---|---|---|
| | 5.940 | 0.05 | 0.1 | 0.2 | 0.3 | 0.4 | 0.5 | 0.75 | 0.9 | 0.95 |
| Range | 100 | −8.98 | −2.94 | 3.12 | 6.72 | −0.01 | 11.42 | 15.61 | 18.02 | 19.00 |
| | 200 | −14.19 | −8.16 | −2.10 | 1.50 | −5.23 | 6.20 | 10.39 | 12.81 | 13.78 |
| | 300 | −17.50 | −11.47 | −5.41 | −1.81 | −8.54 | 2.89 | 7.08 | 9.49 | 10.47 |
| | 400 | −19.95 | −13.92 | −7.86 | −4.26 | −10.99 | 0.44 | 4.63 | 7.04 | 8.02 |
| | 500 | −21.91 | −15.88 | −9.82 | −6.22 | −12.95 | −1.52 | 2.67 | 5.09 | 6.06 |
| | 750 | −25.62 | −19.59 | −13.53 | −9.93 | −16.65 | −5.23 | −1.04 | 1.38 | 2.35 |
| | 1,000 | −28.40 | −22.37 | −16.31 | −12.71 | −19.44 | −8.01 | −3.82 | −1.40 | −0.43 |
| | 1,500 | −32.66 | −26.63 | −20.56 | −16.97 | −23.69 | −12.26 | −8.08 | −5.66 | −4.68 |
| | 2,000 | −36.11 | −30.08 | −24.02 | −20.42 | −27.15 | −15.72 | −11.53 | −9.12 | −8.14 |

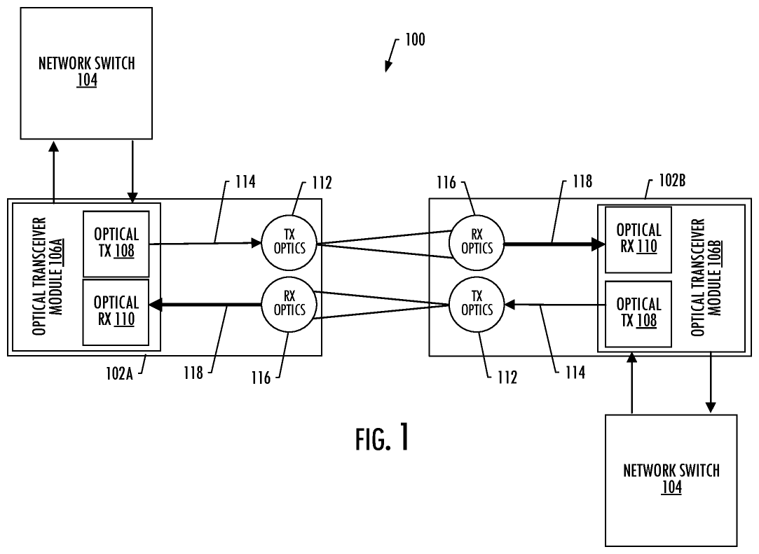

FIG. 1 illustrates an optical communication system 100 according to some example implementations of the present disclosure. As shown, the optical communication system comprises a plurality of nodes including a first node 102A and a second node 102B. Each node is an active, physical, electronic device in a telecommunications network that is configured to send, receive or forward signals. A node may be either a redistribution point or a communication endpoint in a telecommunications network.

Each of the nodes may be coupled to a network switch 104 configured to receive signals from and forward signals to the nodes. Each of the nodes also includes a respective optical transceiver module. As shown, the first node 102A includes a first optical transceiver module 106A, and the second node 102B includes a second optical transceiver module. Each optical transceiver module includes an optical transmitter 108 with at least one laser or other emitter, and an optical receiver 110 with at least one detector. The optical transceiver module is connected to transmit optics 112 using a small fiber 114, and the optical transceiver module is connected to receive optics 116 using a large fiber 118.

As indicated above, the large fiber 118 is an optical fiber with a diameter and/or NA greater than the current standard SM fiber having a core diameter of about 9 microns, and NA of about 0.1. In some examples, the large fiber has core diameter greater than 10 micrometers. Additionally, or alternatively, in some examples, the large fiber has a NA of at least 0.1. In some example implementations, the large fiber may be a mode-conditioning cable. Further network switch can be replaced by a device capable of receiving the signal from an optical transceiver module. The device could be a fiber network card, SFP to thunderbolt converters, etc.

The optical transceiver modules 106A,106B may be fitted with a custom receiver with a large sized detector, a high acceptance angle or both. The transmit optics 112 may be fitted with an opto-mechanical assembly to transmit signals, which may be received by the receive optics 116 of the second node 102B. The receive optics of the second node is connected to the second transceiver module 106B by a large fiber 118 that carries the signal to the second optical transceiver module 106B. The second transceiver module may be connected to a network switch 104. Similarly, signals may be transmitted from the second node to the first node 102A to establish a full duplex connection.

The optical transceiver modules 106A, 106B connected to the network switches 104 may be off the shelf (OTS) modules and may be built under multi-source agreements (MSA) by one or more manufacturers. Some examples of suitable optical transceiver modules include small form-factor pluggable (SFP), SFP+, SFP28 and quad SFP (QSFP) modules. Other OTS modules may be used as well. SFP module typical speeds may be 1 Gbit/s for Ethernet SFPs, and up to 4 Gbit/s for Fibre Channel SFP. The SFP+ specification brought speeds up to 10 Gbit/s, and the SFP28 iteration is designed for speeds of 25 Gbit/s.

A slightly larger sibling is the four-lane QSFP, which allows for speeds four times their corresponding SFP. The QSFP28 variant allows speeds up to 100 Gbit/s, and the closely-related QSFP56 standard doubles the top speeds to 200 Gbit/s with products already selling from major vendors. There are also inexpensive adapters allowing SFP transceivers to be placed in a QSFP port.

Even further examples include SFP double density (SFP-DD) that allows for 100 Gbit/s over two lanes, and QSFP double density (QSFP-DD) that allows for 400 Gbit/s over eight lanes. These standards use a form factor that is backward compatible to their respective predecessors. The octal small format pluggable (OSFP) is an alternative competing solution that is also intended for 400 Gbit/s fiber optic links between network equipment via 8×50 Gbit/s electrical data lanes. It is slightly larger version than the QSFP form factor that is capable of handling larger power outputs. These and other variants may be suitable for example implementations of the present disclosure. Future versions of these types of modules may have higher throughput, including 800 Gbit/sec, 1 Terabit/sec, 10 Tbit/sec, 100 Tbit/sec and the like. Data rates in between these values will also work in various example implementations.

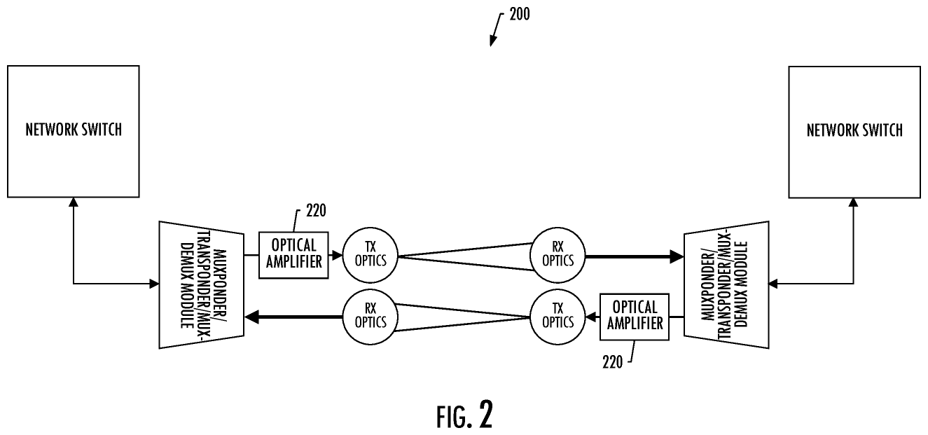

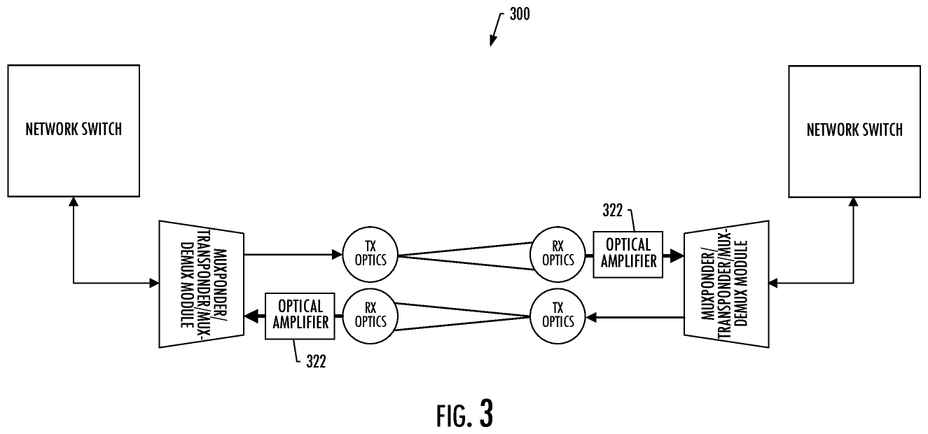

Some example implementations may include one or more optical amplifiers such as one or more erbium doped fiber amplifiers (EDFA) to provide gain in the optical portion of the link. Optical amplifiers such as EDFAs may be single stage or multiple stage. EDFAs may work in the C band (from ˜1525 nm to ˜1565 nm), L band (rom ˜1565 nm to ˜1610 nm), S band (˜1490 nm to ˜1525 nm) or some combination. FIG. 2 illustrates a portion of an optical communication system 200 similar to the system 100 shown in FIG. 1, further including an optical amplifier 220 between the network switch and transmit optics. FIG. 3 illustrates a portion of an optical communication system 300 similar to the system shown in FIG. 1, further including an optical amplifier 322 between the receive optics and the network switch. In some example implementations, an optical communication system may include both an optical amplifier 220 and an optical amplifier 322. Further, signals from multiple optical transceiver modules coupled to a network switch may be combined into a single signal by means of a device such as a muxponder, transponder, etc.

Some example implementations may use other fiber-coupled amplifier technologies such as SOA (semiconductor optical amplifiers), fibers doped with neodymium, ytterbium (YDFA), praseodymium, or thulium, or the like. Some implementations may use EYDFAs (erbium ytterbium doped fiber amplifiers) particularly in cases where high output power is desired.

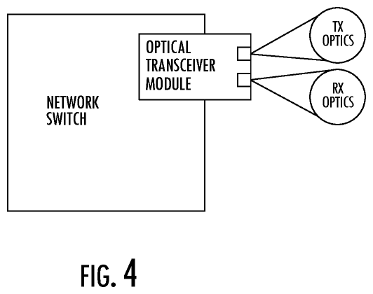

As shown in FIG. 4, in some example implementations, the transmit optics and receive optics may be coupled directly to respectively the at least one emitter and the at least one detector of the optical transceiver module, without any optical fiber. This may allow the optical receiver to use more of the etendue of the detector than would be possible with SM fiber. As an example, there are SFP modules in which the detector is 30 microns in diameter with an acceptance angle of approximately 45 degrees. But these SFP modules are typically used with SMF-28 fiber which has a core diameter of 9 microns and an acceptance angle of approximately 15 degrees. The etendue of the detector is therefore approximately 100 times larger than the SM fiber. By matching the receive optics to etendue of the detector, the received signal may be increased up to the limit of ratio of the etendues. Specifically, the receive power using the free space coupling may be increased by 2, 5, 10, 20, 50 or 100 times the receiver power coupled through SM fiber. Further, the optical transceiver module may have a custom detector, which may be constructed from an off the shelf (OTS) detector to include an array of detectors, increased acceptance angle, increased detector size, etc.

In some examples, a MM fiber may be used between the receive optics and the optical receiver in the optical transceiver module. The etendue of the MM fiber will typically be larger than the etendue of the detector in the optical receiver. This may overfill the detector, but will increase the amount of receive power that reaches the detector. A MM fiber normally cannot be used for high bandwidth transmissions due to mode-mixing, polarization effects, and dispersion in the fiber. But the section of MM fiber may be sufficiently short as to not impact the optical signal beyond an acceptable level. Note that the free space portion of the link has significantly less dispersion than any optical fiber, including SMF and other SM fibers. In some examples, the section of MM fiber may be less than 5 cm long. In other examples, the section of MM fiber may be between 5 cm and cm long. In yet other examples, the section of MM fiber may be between 10 cm and 20 cm long, between 20 cm and 1 meter, or longer than 1 meter.

In some example implementations, the section of MM fiber may have a lens or other optics between the end of the fiber and the detector in the optical receiver of the optical transceiver module. In some implementations, the optics may be a GRIN lens (gradient index). In some implementations, this may be a singlet lens or a doublet lens or an achromat lens or a ball lens. The MM fiber with lens assembly may be small enough to fit inside a channel where the fiber would typically go. As an example, SFP modules use LC/PC fiber pairs, one for the transmitter and one for the receiver. In some example implementations, the transmitter fiber may be a SM fiber, and on the receive side there may be a MM fiber with a GRIN lens with the same outer diameter as the LC/PC connector.

In some examples, the system may have sufficient laser divergence and detector acceptance angle that active pointing and tracking is not needed. That is, the endpoints of a link may be aligned at time of installation and then not modified for longer than some time period such as a day, a week, a month, or a year. The system may be realigned at some time period either in response to degradation or loss of communications, or the system may be preemptively realigned based on some criteria including, but not limited to, changes in signal level, changes in bit error rate, or elapse of some time period. Realignment means an outside entity interacts with the node and changes some aspect of the node alignment. This may be a technician, but could also be other service personnel or another piece of equipment that is used to adjust the node alignment.

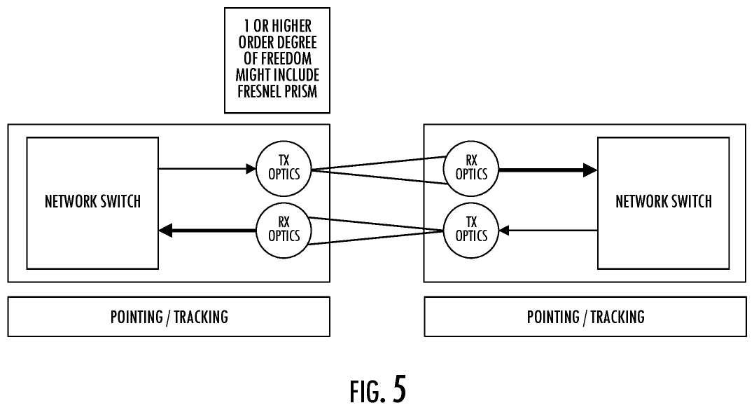

As shown in FIG. 5, in some implementations, one or more nodes may include active pointing and/or tracking, which may be used for link acquisition, maintaining link alignment and the like. The resolution of the pointing and tracking may be less than the beam divergence of the optical transmitter, and less than the acceptance angle of the receive optics. In some examples, the pointing and tracking may have a resolution less than 1 mrad. In other examples, the pointing and tracking may have a resolution between 1 mrad and 10 mrad. In yet other examples, the pointing and tracking may have a resolution between 10 mrad and 17 mrad (1 degree). In further examples, the pointing and tracking may have a resolution between 17 mrad and 85 mrad (5 degrees). And in even further examples, the pointing and tracking may have a resolution between 85 mrad and 170 mrad (10 degrees).

In some examples including active alignment, the node may include an assembly with the optical transceiver module, one or more optical amplifiers, optical fibers, and the transmit and receive optics, which may all be moved together using the same mechanism. This mechanism may be motorized. The motors may be stepper motors, servo motors or other motors.

In some examples, the system may use rotating prisms for active pointing and/or tracking. Typically, two or more prisms are used to point an optical beam (often referred to a Risley prisms). Some examples may include one set of prisms that are large enough to cover both the transmit and receive optics; and other examples may include a set of prims for the transmit optics and another set for the receive optics. In some examples, one or more of the prisms in the prism set may be Fresnel prisms; and in some of these examples, the Fresnel prisms may be glass, molded or molded plastic, or the like.

As explained above and reiterated below, the present disclosure includes, without limitation, the following example implementations.
Clause 1. An optical communication system comprising: a first node and a second node, each node of which includes: transmit optics; receive optics; and an optical transceiver module configured to provide optical signals to the transmit optics over a first optical conduit, and receive optical signals from the receive optics over a second optical conduit that has a core diameter larger than the first optical conduit, and wherein the transmit optics of the first node is configured to transmit first optical signals in free space for receipt by the receive optics of the second node, and the transmit optics of the second node is configured to transmit the second optical signals in free space for receipt by the receive optics of the first node.
Clause 2. The optical communication system of clause 1, wherein the first optical conduit is a single-mode (SM) fiber, and the second optical conduit is a multi-mode (MM) fiber.
Clause 3. The optical communication system of clause 1 or clause 2, wherein the second optical conduit is an optical fiber with a core diameter greater than 9 micrometers.
Clause 4. The optical communication system of any of clauses 1 to 3, wherein the second optical conduit is an optical fiber with a numerical aperture of at least 0.1.
Clause 5. The optical communication system of any of clauses 1 to 4, wherein the second optical conduit is a mode conditioning fiber.
Clause 6. The optical communication system of any of clauses 1 to 5, wherein the transmit optics is configured to transmit the first optical signals in free space, and the transmit optics of the second node is configured to transmit the second optical signals in free space, with a divergence angle between 1 and 5 degrees, 5 and 20 degrees, 20 and 60 degrees, 60 and 120 degrees, 120 and 180 degrees, or 180 and 360 degrees.
Clause 7. The optical communication system of any of clauses 1 to 6, wherein the optical transceiver module is a small form-factor pluggable (SFP), SFP+, SFP28, quad SFP (QSFP), four-lane QSFP, or SFP double density (SFP-DD) module.
Clause 8. The optical communication system of any of clauses 1 to 7, wherein each of the first node and the second node further includes a multiplexer/demultiplexer configured to pass optical signals to the transmit optics over the first optical conduit, and receive optical signals from the receive optics over the second optical conduit.
Clause 9. The optical communication system of any of clauses 1 to 8, wherein the optical transceiver module includes an optical receiver with at least one customized detector constructed from an off the shelf detector.
Clause 10. An optical communication system comprising: transmit optics configured to receive first optical signals over a first optical conduit, and transmit the first optical signals in free space; and receive optics configured to receive second optical signals from free space, and pass the second optical signals over a second optical conduit that has a core diameter larger than the first optical conduit.
Clause 11. The optical communication system of clause 10, wherein the first optical conduit is a single-mode (SM) fiber, and the second optical conduit is a multi-mode (MM) fiber.
Clause 12. The optical communication system of clause 10 or clause 11, wherein the second optical conduit is an optical fiber with a core diameter greater than 9 micrometers.
Clause 13. The optical communication system of any of clauses 10 to 12, wherein the second optical conduit is an optical fiber with a numerical aperture of at least
Clause 14. The optical communication system of any of clauses 10 to 13, wherein the second optical conduit is a mode conditioning fiber.
Clause 15. The optical communication system of any of clauses 10 to 14 further comprising an optical transceiver module configured to provide the first optical signals to the transmit optics over the first optical conduit.
Clause 16. The optical communication system of any of clauses 10 to 15 further comprising an optical transceiver module configured to receive the second optical signals from the receive optics over the second optical conduit.
Clause 17. The optical communication system of any of clauses 10 to 16, wherein the transmit optics is configured to transmit the first optical signals in free space, and the transmit optics of the second node is configured to transmit the second optical signals in free space, with a divergence angle between 1 and 5 degrees, 5 and 20 degrees, and 60 degrees, 60 and 120 degrees, 120 and 180 degrees, or 180 and 360 degrees.
Clause 18. The optical communication system of clause 17, wherein the optical transceiver module is a small form-factor pluggable (SFP), SFP+, SFP28, quad SFP (QSFP), four-lane QSFP, or SFP double density (SFP-DD) module.
Clause 19. The optical communication system of any of clauses 10 to 18 further comprising a multiplexer/demultiplexer configured to pass the first optical signals to the transmit optics over the first optical conduit, and receive the second optical signals from the receive optics over the second optical conduit.
Clause 20. The optical communication system of any of clauses 10 to 19 further comprising an optical transceiver module coupled to the transmit optics and the receive optics, the optical transceiver module including an optical receiver with at least one customized detector constructed from an off the shelf detector.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An optical communication system comprising:
a first node and a second node, each node of which includes:
transmit optics;
receive optics; and
an optical transceiver module configured to provide optical signals to the transmit optics over a first optical conduit, and receive optical signals from the receive optics over a second optical conduit that has a core diameter larger than the first optical conduit, and
wherein the transmit optics of the first node is configured to transmit first optical signals in free space for receipt by the receive optics of the second node, and the transmit optics of the second node is configured to transmit the second optical signals in free space for receipt by the receive optics of the first node.

2. The optical communication system of claim 1, wherein the first optical conduit is a single-mode (SM) fiber, and the second optical conduit is a multi-mode (MM) fiber.

3. The optical communication system of claim 1, wherein the second optical conduit is an optical fiber with a core diameter greater than 9 micrometers.

4. The optical communication system of claim 1, wherein the second optical conduit is an optical fiber with a numerical aperture of at least 0.1.

5. The optical communication system of claim 1, wherein the second optical conduit is a mode conditioning fiber.

6. The optical communication system of claim 1, wherein the transmit optics is configured to transmit the first optical signals in free space, and the transmit optics of the second node is configured to transmit the second optical signals in free space, with a divergence angle between 1 and 5 degrees, 5 and 20 degrees, 20 and 60 degrees, 60 and 120 degrees, 120 and 180 degrees, or 180 and 360 degrees.

7. The optical communication system of claim 1, wherein the optical transceiver module is a small form-factor pluggable (SFP), SFP+, SFP28, quad SFP (QSFP), four-lane QSFP, or SFP double density (SFP-DD) module.

8. The optical communication system of claim 1, wherein each of the first node and the second node further includes a multiplexer/demultiplexer configured to pass optical signals to the transmit optics over the first optical conduit, and receive optical signals from the receive optics over the second optical conduit.

9. The optical communication system of claim 1, wherein the optical transceiver module includes an optical receiver with at least one customized detector constructed from an off the shelf detector.

10. An optical communication system comprising:
transmit optics configured to receive first optical signals over a first optical conduit, and transmit the first optical signals in free space; and
receive optics configured to receive second optical signals from free space, and pass the second optical signals over a second optical conduit that has a core diameter larger than the first optical conduit.

11. The optical communication system of claim 10, wherein the first optical conduit is a single-mode (SM) fiber, and the second optical conduit is a multi-mode (MM) fiber.

12. The optical communication system of claim 10, wherein the second optical conduit is an optical fiber with a core diameter greater than 9 micrometers.

13. The optical communication system of claim 10, wherein the second optical conduit is an optical fiber with a numerical aperture of at least 0.1.

14. The optical communication system of claim 10, wherein the second optical conduit is a mode conditioning fiber.

15. The optical communication system of claim 10 further comprising an optical transceiver module configured to provide the first optical signals to the transmit optics over the first optical conduit.

16. The optical communication system of claim 10 further comprising an optical transceiver module configured to receive the second optical signals from the receive optics over the second optical conduit.

17. The optical communication system of claim 10, wherein the transmit optics is configured to transmit the first optical signals in free space, and the transmit optics of the second node is configured to transmit the second optical signals in free space, with a divergence angle between 1 and 5 degrees, 5 and 20 degrees, 20 and 60 degrees, 60 and 120 degrees, 120 and 180 degrees, or 180 and 360 degrees.

18. The optical communication system of claim 17, wherein the optical transceiver module is a small form-factor pluggable (SFP), SFP+, SFP28, quad SFP (QSFP), four-lane QSFP, or SFP double density (SFP-DD) module.

19. The optical communication system of claim 10 further comprising a multiplexer/demultiplexer configured to pass the first optical signals to the transmit optics over the first optical conduit, and receive the second optical signals from the receive optics over the second optical conduit.

20. The optical communication system of claim 10 further comprising an optical transceiver module coupled to the transmit optics and the receive optics, the optical transceiver module including an optical receiver with at least one customized detector constructed from an off the shelf detector.
